(19) United States
(12) Patent Application Publication
(10) Pub. No.: US 2011/0232453 A1
(43) Pub. Date: Sep. 29, 2011

(54) CUTTING AID

(76) Inventor: Felicitas FACKELMANN, Hersbruck (DE)

(21) Appl. No.: 12/732,672

(22) Filed: Mar. 26, 2010

(51) Int. Cl. A21C 15/04

(52) U.S. Cl. 83/821

(57) ABSTRACT

The invention relates to a cutting aid for facilitating the cutting of cake, having a ring body, the ring body radially limiting a cake-accommodating space for receiving a cake to be cut, an inner wall for at least partially abutting against the edge of the cake to be cut, and at least one guide aperture for guiding a cutting apparatus for cutting the cake.

### FIELD OF THE INVENTION

The invention relates to a cutting aid for facilitating the cutting of cake. Cake here is especially understood to mean sheet cake, cake baked in a baking tin, filled cakes such as gateaus, savory cakes such as onion cakes, tartes flambée or the like. With the aid of the cutting aid it is also easily possible to cut cake bottoms or cake bases such as such as sponge cake bases, which may be or may become part of a cake. The cakes to be cut preferably have a round or polygonal shape.

### BACKGROUND OF THE INVENTION

It is known for a cake base to be cut into several layers using a pointed knife. To this end, the knife is inserted into the cake base to its centre. The cake base is then turned until the desired layer has been severed. This requires a great deal of skill and practice. Especially the making of very thin layers is very difficult. The layers often do not exhibit a constant height, which is not visually pleasing.

### SUMMARY OF THE INVENTION

The invention is therefore based on the object of providing a cutting aid for facilitating the cutting of cake, with which a cake can be cut in an uncomplicated, precise and efficient manner.

According to the invention, said object is achieved by a cutting aid for facilitating the cutting of cake, having a ring body, whereby the ring body radially limits a cake-accommodating space for receiving a cake to be cut, exhibits an inner wall for at least partially abutting against the edge of the cake to be cut, and exhibits at least one guide aperture for guiding a cutting apparatus for cutting the cake. The core of the invention consists in a ring-shaped body exhibiting at least one guide aperture for guiding a cutting apparatus to sever or cut through an accommodated cake. Through the contact between the inner wall of the ring body and the edge of the cake, a relative movement between the cake and the cutting aid can be prevented. A cutting apparatus can be a cutting knife, a tear-proof yarn or a dividing plate.

In the following, two preferred embodiments of the invention are described with reference to the drawings attached.

### BRIEF DESCRIPTION OF THE DRAWINGS

FIG. 1 a perspective view of a cutting aid according to the invention according to a first embodiment from a first direction,

FIG. 2 a perspective view of the cutting aid shown in FIG. 1 from a second direction, which is shifted by approximately 90° relative to the first direction, and

FIG. 3 a perspective view of a cutting aid according to the invention according to a second embodiment.

### DESCRIPTION OF THE PREFERRED EMBODIMENTS

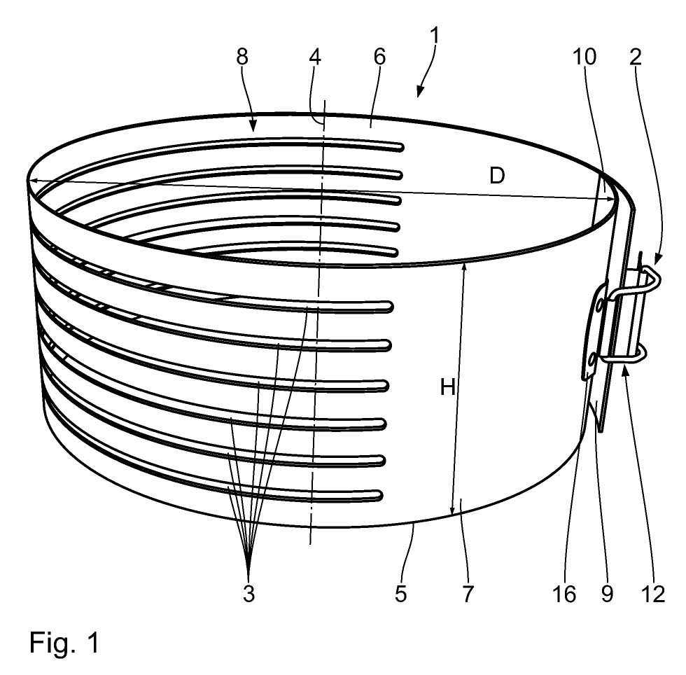

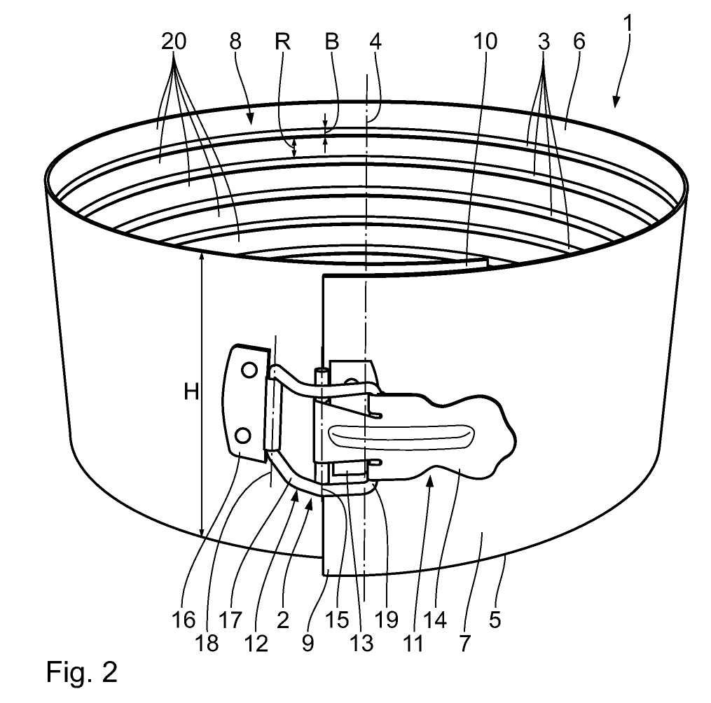

Referring now to FIGS. 1 and 2, a cutting aid according to the first embodiment comprises a ring body 1 and a tension fastener 2 to close and clamp the ring body 1. Inside the ring body 1a cake (not shown) may be accommodated on the inside for said cake to be cut or divided. To this end there is envisaged in the ring body 1 at least one guide aperture 3 for guiding a cutting apparatus.

In the following, the cutting aid is described in more detail with reference to its intended use. The ring body 1 essentially exhibits the shape of a thin-wall cylinder jacket or a hollow cylinder which is open at the bottom and the top. It is formed by a bent strip of stainless steel sheet, which may be clamped and is a little flexible. The ring body 1 has a central longitudinal axis 4, which extends vertically in the centre of the ring body 1. At the bottom the ring body 1 exhibits a straight base edge 5, which spans a level standing surface for placing the ring body 1 onto another surface, or a standing plane. For example, the ring body 1 may be placed with its base edge 5 onto a table, an underlay, or a cake or gateau plate or the like.

The ring body 1 has a constant, vertical height H, which is oriented in the direction of the central longitudinal axis 4. The height H ranges from 3 cm to 20 cm, preferably from 5 cm to 10 cm. The ring body 1 exhibits a constant diameter D, which is between 15 cm and 35 cm, preferably between 20 cm and 30 cm. It also has an inner wall 6 and an outer wall 7 lying opposite to the inner wall 6. The inner wall 6 faces the central longitudinal axis 4, while the outer wall 7 faces away from the central longitudinal axis 4. The inner wall 6 limits radially or towards the outside a cake-accommodating space 8, which is essentially ring-shaped. In the cake-accommodating space 8 there may be accommodated a cake to be cut.

The ring body 1 exhibits a first tensioning end 9 and a second tensioning end 10, which, with the ring body 1 closed, are situated essentially adjacent to each other. The two tensioning ends 9, 10 are arranged to overlap. Here, the tensioning ends 9, 10 are understood as areas, which extend from the two closing vertical edges of the ring body 1, the first tensioning end 9 running along the outside while the second tensioning end 10 runs along the inside. On the tensioning ends 9, 10 there is affixed on the outside the tension fastener 2, which is essentially made up of two parts 11, 12. Part 11, which is allocated to the first tensioning end 9, comprises a fastening element 13 affixed to the tensioning end 9, the fastening element 13 being designed as a fitting riveted to the outside of the tensioning end 9. Moreover, part 11 comprises a tensioning lever 14, which is swingably mounted with its base on the fastening element 13. The tensioning lever 14 is swingable about a vertical swing axis 15, which extends in parallel to the central longitudinal axis 4. On the tensioning lever 14 there is envisaged, at a distance from its base, an inner receptacle. Moreover, the tensioning lever 14 has an actuating section to actuate it manually.

Part 12, which is affixed to the second tensioning end 10, comprises a fastening element 16, which is again designed as a fitting and riveted to the outside of the tensioning end 10. On the fastening element 16 a tensioning bracket 17 is swingably mounted. The tensioning bracket 17, which is also a constituent of part 12, is swingable about a vertical swing axis 18, which runs parallel to the swing axis 15 of the tensioning lever 14.

In order to close and clamp the ring body 1, the free end 19 of the tensioning bracket 17 must be inserted into the receptacle of the tensioning lever 14. When the tensioning lever 14 is then swung to the outer wall 7 of the tensioning end 9, the ring body 1 is pulled together via the tensioning bracket 17 and the fastening element 16, and is thus clamped. When the tension fastener 2 is opened, however, the ring body 1 again expands.

In the ring body 1 there are envisaged a plurality of punched-out guide apertures 3, which fully penetrate the ring body 1, thereby creating a connection between the inner wall 6 and the outer wall 7. They are of an identical design and exhibit the shape of a slot. The guide apertures 3, which are arranged above each other, run parallel to the base edge 5 and are thus horizontally oriented. The guide apertures 3 practically predetermine various cutting levels, which are parallel to the base level. The guide apertures 3 thus extend vertically to the central longitudinal axis 4. They each exhibit a constant width B in the direction of the central longitudinal axis 4 of 6 mm to 10 mm, preferably of 8 mm. Adjacent to a guide aperture 3 there are in each case guide webs 20, which each have a constant height R in the direction of the central longitudinal axis 4 of 6 mm to 10 mm, preferably of 8 mm. The distance between guide apertures 3 is thus also constant.

The guide apertures 3 are arranged vertically above each other in the direction of central longitudinal axis 4, so that the guide apertures 3 run at different heights of the ring body 1. The guide apertures 3 in the ring body 1 extend about the central longitudinal axis 4 over an angle range stretching from 100° to 350°, preferably from 150° to 250°. The part of the ring body 1, into which the guide apertures 3 do not extend, serves as a holding section for the guide webs 20. A total of six guide apertures 3 are envisaged here. Preferably there are six to ten guide apertures 3. Especially preferred are eight guide apertures 3.

During the use of the cutting aid, the cake to be cut is inside cake-accommodating space 8, the ring body 1 extending around the cake, which preferably has a round shape. The cake must be inserted into the cake-accommodating space 8 of the ring body 1 with the tension fastener 2 opened. The ring body 1 is preferably held in hand and put down from the top so that it encircles the cake. However, conversely, the cake may also be inserted from the top into the cake-accommodating space 8. The ring body 1 then stands with its base edge 5 safely on a carrying surface, which—as already mentioned—can be a conventional cake plate.

The tension fastener 2 then has to be closed by actuating the tensioning lever 14, whereby the ring body 1 clamped and thus attains a slightly smaller diameter D. The size of the ring body 1 has been selected such that the inner wall 6 of the clamped ring body 1 abuts on the outside against the vertical side edge of the cake over an angle range of at least 180°, preferably of at least 320°. The inner wall 6 thus preferably abuts against the cake roughly over the full circumference thereof. The cake is then secured on the side in its position inside the ring body 1, so that it cannot be displaced crosswise relative to the central longitudinal axis 4.

A cutting apparatus can now be inserted via a guide aperture 3 or via several guide apertures 3 from the outside through the side edge of the cake into the cake, which is fixed in place, and be moved along the entire guide aperture(s) 3. The blade of a cutting knife, for example, can be inserted into the cake sideways and/or horizontally.

Thereafter, the tension fastener 2 must again be opened and the ring body 1 must be turned relative to the cake, so that the cutting of the cake can be completed. This is necessary since the guide apertures 3 do not extend over the full circumference of the ring body 1. Depending on the cutting actions performed, the cake is cut into one horizontal layer or slice or several horizontal layers or slices, which, thanks to the guide apertures 3, each have a constant thickness or height.

It is possible for the cake to be cut in the clamped position via several guide apertures 3. The cake can also be divided only once at a desired height. To this end, a corresponding guide aperture 3 for cutting the cake must be chosen.

In the following there is described a second preferred embodiment of the invention. Identical parts carry the same reference numerals as for the first embodiment, reference to the description of which is hereby made. Functionally like components, which are of a different design, receive the same reference numerals followed by an ‘a’. Compared with the first embodiment, the second embodiment has a different tension fastener. According to the second embodiment, the tension fastener 2a is designed such that the ring body 1 can be held in different size positions. To this end, the tension fastener 2a exhibits several, preferably two, receptacles for the tensioning bracket 17a, which are arranged at a distance to each other.

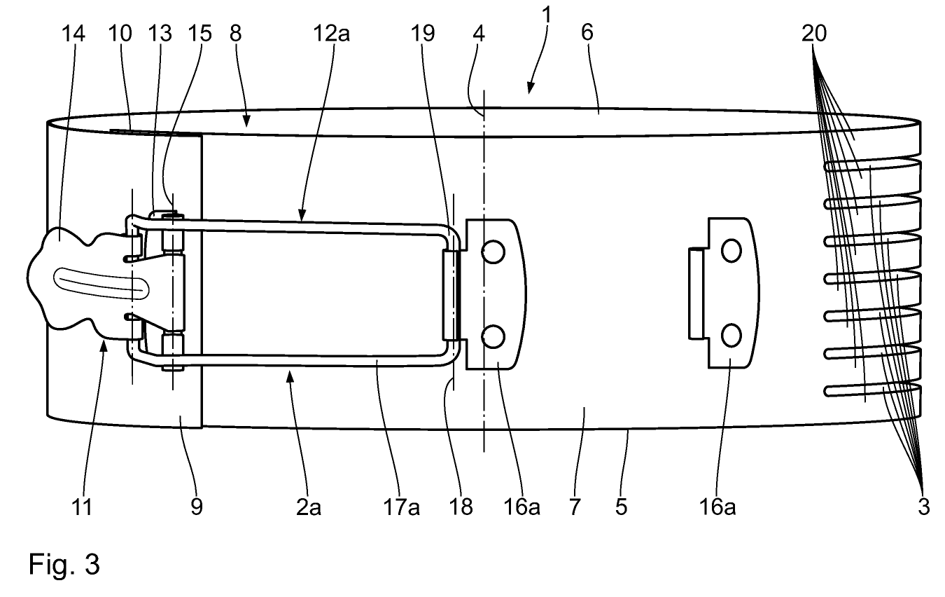

According to FIG. 3 there are envisaged two separate fastening elements 16a on the second tensioning end 10, which each have a receptacle to receive or store the free end 19 of the tensioning bracket 17a. The receptacles or the fastening elements 16a are arranged at a distance to each other along the circumferential direction of the ring body 1. The receptacles are oriented in the direction of the central longitudinal axis 4. The receptacles or the fastening elements 16a thus have a different distance to the tensioning lever 14. The free end 19 of the tensioning bracket 17a can thus be inserted into one of the receptacles. Consequently, the cutting aid can, in the closed position of the tension fastener 2a, exhibit different predefined diameters D. When the tensioning bracket 17a is clipped into the receptacle located further away from the tensioning lever 14, then the diameter D of the ring body 1 with the tension fastener 2a closed is approximately 26 cm, while the diameter D is approximately 28 cm when the tensioning bracket 17a is inserted into the receptacle arranged closer to the tensioning lever 14. It is thus possible to cut cakes of different diameters through the adjustable tension fastener 2a.

Alternatively, the two separate fastening elements 16a are connected with each other as one peace, thus forming a unit. Said unit again comprises several receptacles, which are positioned at a distance to each other in the circumferential direction of the ring body 1 so that cakes of different sizes can be cut. According to an alternative embodiment there are envisaged on the tensioning lever 14 several inner receptacles that are arranged at different distances to the base of the tensioning lever 14. Through this, too, the ring body 1 can exhibit different diameters D in the clamped state.

According to another embodiment, retaining projections are envisaged on the outer wall 7 of the ring body 1 instead of the tension fastener 2, 2a. One retaining projection is affixed on each tensioning end 9, 10. The retaining projections are positioned at the same height of ring body 1 and have an angular shape. They are each attached to the ring body 1 with one leg. In contrast, the free legs of the retaining projections, which legs project essentially radially from the ring body 1, may be grasped by a user of the cutting aid with one hand. Using the retaining projections, the ring body 1 may be compressed over a certain range by hand into any size, so that here a quasi stepless adjustment of the diameter D is possible over a certain range. However, it is, for example, also possible to run a rubber band over the retaining projections to obtain the desired diameter D of the ring body 1.

Using the cutting aid, unskilled persons can easily cut thin cake slices, which may be used, for example, for making a “Prinzregententorte” sponge cake. A Prinzregententorte comprises at least six thin layers and chocolate butter cream.

What is claimed is:

1. A cutting aid for facilitating the cutting of cake, having a ring body (1), whereby the ring body (1)
a) radially limits a cake-accommodating space (8) for receiving a cake to be cut,
b) exhibits an inner wall (6) for at least partially abutting against the edge of the cake to be cut, and
c) exhibits at least one guide aperture (3) for guiding a cutting apparatus for cutting the cake.

2. A cutting aid according to claim 1, wherein the at least one guide aperture (3) has a slot-type design.

3. A cutting aid according to claim 1, wherein the at least one guide aperture (3) extends over an angle range stretching from 100° to 350° in the ring body (1).

4. A cutting aid according to claim 1, wherein the at least one guide aperture (3) extends over an angle range stretching from 150° to 250° in the ring body (1).

5. A cutting aid according to claim 1, wherein the at least one guide aperture (3) exhibits a width B of 6 mm to 10 mm.

6. A cutting aid according to claim 1, wherein the at least one guide aperture (3) exhibits a width B of 8 mm.

7. A cutting aid according to claim 1, wherein the ring body (1) has the shape of a cylinder jacket.

8. A cutting aid according to claim 1, wherein the ring body (1) is formed from a metal sheet.

9. A cutting aid according to claim 1, wherein the at least one guide aperture (3) runs essentially vertically to a central longitudinal axis (4) of the ring body (1).

10. A cutting aid according to claim 1 wherein the inner wall (6) runs in the direction of the central longitudinal axis (4) of the ring body (1).

11. A cutting aid according to claim 1, wherein the inner wall (6) is envisaged to abut over at least half the circumference of the cake.

12. A cutting aid according to claim 1, wherein the inner wall (6) is envisaged to abut over essentially the entire circumference of the cake.

13. A cutting aid according to claim 1, wherein the ring body (1) exhibits a height H of 3 cm to 20 cm.

14. A cutting aid according to claim 1, wherein the ring body (1) exhibits a height H of 5 cm to 10 cm.

15. A cutting aid according to claim 1, wherein the ring body (1) exhibits at least two guide apertures (3), which are arranged above each other.

16. A cutting aid according to claim 15, wherein the ring body (1) exhibits at least three guide apertures (3), which have an identical distance R to each other.

17. A cutting aid according to claim 16, wherein the distance R is 6 mm to 10 mm.

18. A cutting aid according to claim 16, wherein the distance R is 8 mm.

19. A cutting aid according to claim 1, wherein the ring body (1) exhibits a first and a second tensioning end (9, 10), the tensioning ends (9, 10) being fixable against each other via an overarching tension fastener (2; 2a).

20. A cutting aid according to claim 19, wherein the tension fastener (2; 2a) exhibits a tensioning part (12; 12a) attached to the second tensioning end (10) and a tensioning lever (14) attached to the first tensioning end (11) for connection with the tensioning part (12; 12a).

21. Cutting aid according to claim 19, wherein the tension fastener (2a) exhibits at least two receptacles for fixing the tensioning ends (9, 10) in different size positions.

22. A cutting aid according to claim 1, wherein the ring body (1) exhibits a first and a second tensioning end (9, 10), a retaining projection for size adjustment of the ring body (1) being envisaged on each tensioning end (9, 10).
